(19) United States
(12) Patent Application Publication
(10) Pub. No.: US 2017/0208609 A1
(43) Pub. Date: Jul. 20, 2017

(54) Time Triggered Communication Channel In A Synchronous Network

(71) Applicant: Microchip Technology Incorporated, Chandler, AZ (US)

(72) Inventor: Ronny Lundstroem, Gothenburg (SE)

(73) Assignee: Microchip Technology Incorporated, Chandler, AZ (US)

(21) Appl. No.: 15/148,008

(22) Filed: May 6, 2016

Related U.S. Application Data
(60) Provisional application No. 62/281,056, filed on Jan. 20, 2016.

(51) Int. Cl. H04W 72/12; H04L 7/00; H04W 72/04

(52) U.S. Cl. CPC H04W 72/1205; H04W 72/0446; H04L 7/0008

(57) ABSTRACT

Systems and method for a time-triggered communication channel in a synchronous network are disclosed. The systems and methods may include communicating in a repeated cycle wherein each of the plurality of nodes has a dedicated slot, wherein a cycle comprises n subsequent slots, and wherein each slot comprises a plurality of frames, defining a centralized schedule that associates each node to an associated slot comprising a start frame and an end frame, and transmitting by each node only during the associated slot comprising said start frame.

### CROSS-REFERENCE To RELATED APPLICATIONS

This application claims priority to commonly owned U.S. Provisional Patent Application No. 62/281,056 filed Jan. 20, 2016; which is hereby incorporated by reference herein for all purposes.

### TECHNICAL FIELD

The present disclosure relates to synchronous serial interfaces, and in particular to a time-triggered communication channel in a synchronous network.

### BACKGROUND

Serial interfaces using either a synchronous protocol are well known in the art. For example, an SPI or I²C interface bus uses two bus lines to separately transmit a clock signal and associated data signals. These type of interfaces are synchronous because the data is transmitted synchronous to the clock signal. Generally, such interfaces are more robust than asynchronous interfaces and allow for higher transmission rates.

Media Oriented Systems Transport (MOST®) is a high-speed multimedia network technology optimized by the automotive industry. It can be used for applications inside or outside the car. The serial MOST® bus uses a ring topology and synchronous data communication to transport audio, video, voice and data signals via plastic optical fiber (POF) (MOST25, MOST150) or electrical conductor (MOST50, MOST150) physical layers.

The MOST® specification defines the physical and the data link layer as well as all seven layers of the ISO/OSI-Model of data communication. Standardized interfaces simplify the MOST® protocol integration in multimedia devices. For the system developer, MOST® is primarily a protocol definition. It provides the user with a standardized interface (API) to access device functionality. The communication functionality is provided by driver software known as MOST® Network Services. MOST® Network Services include Basic Layer System Services (Layer 3, 4, 5) and Application Socket Services (Layer 6). They process the MOST® protocol between a MOST® Network Interface Controller (NIC), which is based on the physical layer, and the API (Layer 7).

The Automotive industry is looking for alternatives to the FlexRay communications protocol, which has a bandwidth of approximately 10-20 Mbps, and is looking to MOST® as an alternative. The channel complements MOST® to become a fully featured and cost-effective solution. There exists a need for a highly deterministic communication channel in MOST® networks.

### SUMMARY

Systems and method for a time-triggered communication channel in a synchronous network are disclosed. The systems and methods may include communicating in a repeated cycle wherein each of the plurality of nodes has a dedicated slot, wherein a cycle comprises n subsequent slots, and wherein each slot comprises a plurality of frames, defining a centralized schedule that associates each node to an associated slot comprising a start frame and an end frame, and transmitting by each node only during the associated slot comprising said start frame.

According to various embodiments, a transmission method in a synchronous network transmitting periodic frames is disclosed. In the synchronous network, each frame includes a plurality of channels, and the network includes a plurality of nodes. The method may include communicating in a repeated cycle wherein each of the plurality of nodes has a dedicated slot, wherein a cycle comprises n subsequent slots, and wherein each slot comprises a plurality of frames, defining a centralized schedule that associates each node to an associated slot comprising a start frame and an end frame, and transmitting by each node only during the associated slot comprising said start frame.

In some embodiments, the systems and methods may also include a master node that defines the schedule, the master node being one of the plurality of nodes. In some embodiments, the schedule is distributed to the plurality of nodes in an out-of-band communication. The schedule may be static, and/or the schedule may be configurable.

In some embodiments, each node may be associated with multiple slots within the repeated cycle. In alternative embodiments, one or more of the slots may be of different sizes. In further embodiments, a cycle length may be configurable. In still further embodiments, a slot may include at least one unused frame. In such embodiments, the unused frame may follow after the end frame of a slot. In alternative embodiments, wherein a slot includes a plurality of unused frames, any unused frames may follow after the end frame of a slot.

In various embodiments, the systems and methods may also include a synchronous network for transmitting periodic frames, wherein each frame comprises a plurality of channels. The synchronous network may include a plurality of nodes communicatively coupled to one another, and a master node. In such embodiments, each of the plurality of nodes may be operable to communicate in a repeated cycle, each of the plurality of nodes may have a dedicated slot, a cycle includes n subsequent slots, each slot includes a plurality of frames, the master node may be operable to define a centralized schedule that associates each of the plurality of nodes to an associated slot comprising a start frame and an end frame, and each of the plurality of nodes may be operable to transmit only during the associated slot comprising said start frame.

In various embodiments, the systems and methods may also include a synchronous network for transmitting periodic frames, wherein each frame comprises a plurality of channels. The synchronous network may include a plurality of nodes communicatively coupled to one another and a participating node operable to receive a centralized schedule from a master node, wherein the centralized schedule associates each of the plurality of nodes to an associated slot comprising a start frame and an end frame. The network may be configured such that each of the plurality of nodes is operable to communicate in a repeated cycle, each of the plurality of nodes has a dedicated slot, a cycle comprises n subsequent slots, each slot comprises a plurality of frames, and the participating node may be operable to transmit only during the associated slot comprising said start frame.

### BRIEF DESCRIPTION OF THE DRAWINGS

FIG. 1 illustrates an example high-level diagram of a communication network in which the time-triggered communication channel may be deployed, in accordance with certain embodiments of the present disclosure;

FIG. 2 illustrates an example network communication frame, in accordance with certain embodiments of the present disclosure;

FIG. 3 illustrates an example communication cycle for communicating data between nodes over a time-triggered synchronous communication channel, in accordance with certain embodiments of the present disclosure;

FIG. 4 illustrates an example cycle detailing an example frame assignment, in accordance with certain embodiments of the present disclosure; and

FIG. 5 illustrates an example system schedule for scheduling a time-triggered synchronous communication channel, in accordance with certain embodiments of the present disclosure.

### DETAILED DESCRIPTION

According to various embodiments, a communication channel can be provided for a synchronous network where all communication is pre-scheduled and transmitters are allowed to transmit on the channel based on a frame count.

According to various embodiment, the solution is intended for a synchronous network with a single master node that generates a bit clock. For the purposes of this disclosure, a “synchronous network” may refer to any appropriate communication network in which data is sent synchronously with a clock signal. For example, the MOST communication protocol describes a synchronous network.

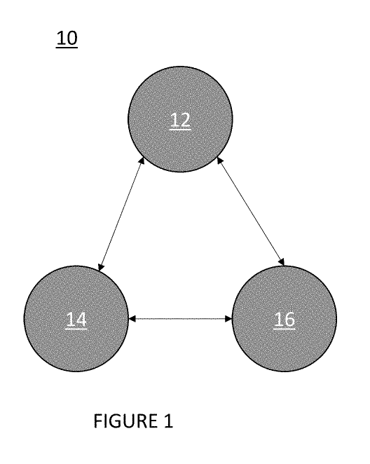

FIG. 1 illustrates an example high-level diagram 10 of a communication network in which the time-triggered communication channel may be deployed, in accordance with certain embodiments of the present disclosure. In some embodiments, diagram 10 illustrates a plurality of nodes 12, 14, 16 interconnected with one another. For the purposes of this disclosure, a “node” may refer to any appropriate communication device operable to electronically communicate with one or more other nodes. For example, a node may be a microprocessor, microcontroller, or other electronic device. Although a particular network topology is illustrated to aid in understanding, one of ordinary skill in the art would recognize that others would be available without departing from the scope of the present disclosure. With reference to the present disclosure, any appropriate topology instituting an appropriate synchronous network would suffice.

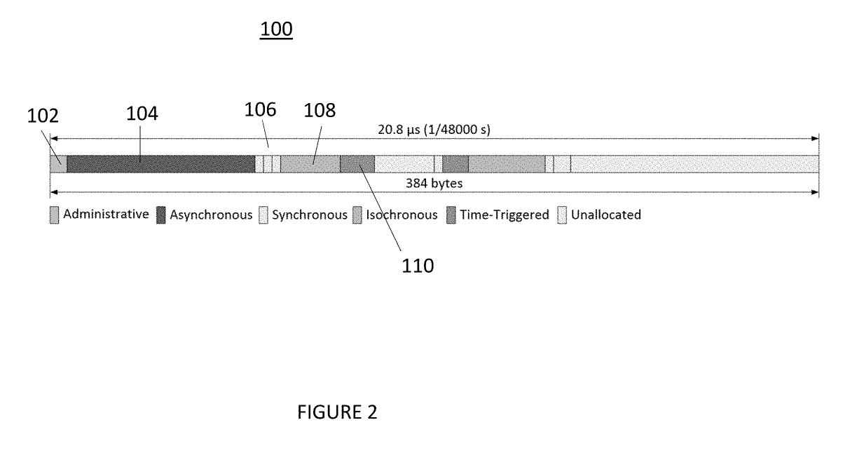

FIG. 2 illustrates an example network communication frame 100, in accordance with certain embodiments of the present disclosure. In some embodiments, frame 100 may include a plurality of channels 102-10. For example, frame 100 may include a plurality of administrative channels, asynchronous channels, synchronous channels, isochronous channels, time-triggered channels, and/or unallocated channels. In the illustrative example of frame 100, a MOST frame is depicted. Such a frame may be sent approximately every 20.8 microseconds with a 48-kHz clock. In this configuration, a frame may be approximately 384 bytes. The allocation of channels within frame 100 may be driven by the performance characteristics of a particular configuration. For example, frame 100 may include administrative channels 102, asynchronous channels 104, synchronous channels 106, isochronous channels 108, and/or time-triggered channels 110, in addition to unallocated channels. Although a certain clock speed, frame length, frame frequency, channel distribution, etc. are illustrated for the purposes of aiding understanding, different configurations would be available to one of ordinary skill in the art without departing from the scope of the present disclosure.

In some embodiments, information appropriate to be transmitted over a time-triggered communication channel may be carried in one or more time-triggered channels 110. In some embodiments, each frame 100 may have an assigned frame number, as described in more detail below. Communication from a particular node in a communication system may be broken up in order to be communicated over a plurality of frames 100.

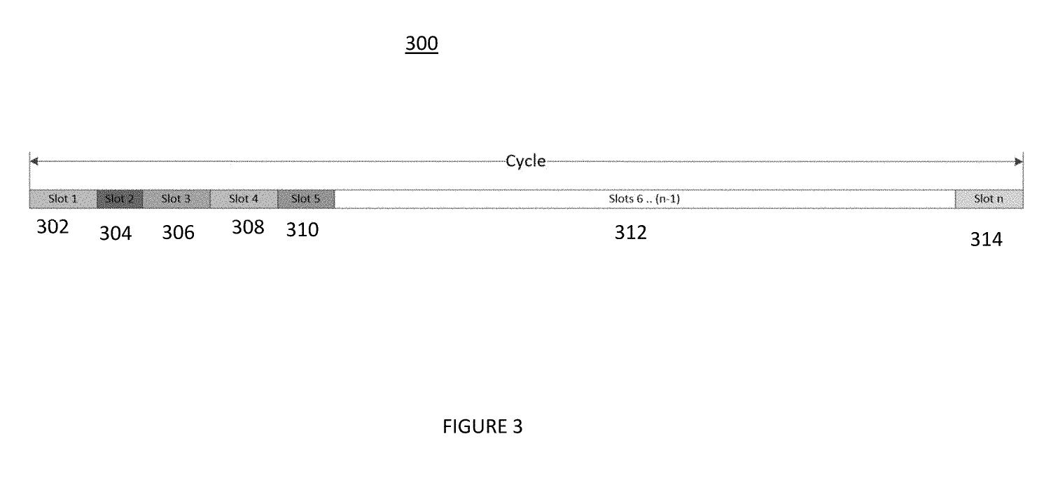

FIG. 3 illustrates an example communication cycle 300 for communicating data between nodes over a time-triggered synchronous communication channel, in accordance with certain embodiments of the present disclosure. In some embodiments, cycle 300 may include a plurality of slots 302, 304, 306, 308, 310, 312, 314. For the purposes of this disclosure, a “slot” refers to a portion of a network cycle that is dedicated to at least a portion of a communication from a particular node. A node may have multiple slots within a cycle. In some embodiments, the cycle length may be configurable. By assigning a node to a slot, each node knows where it is in the communication schedule by knowing its assigned frame number(s). Synchronization of scheduling is described in more detail below.

In the illustrative example of cycle 300, slots 302, 308 may be assigned to a first node, slot 304 to a second node, slot 306 to a third node, slot 310 to a fourth node, etc. To aid in understanding, slots 312, 314 are illustrated in order to demonstrate that more than the referenced number of slots may be available within any particular network cycle.

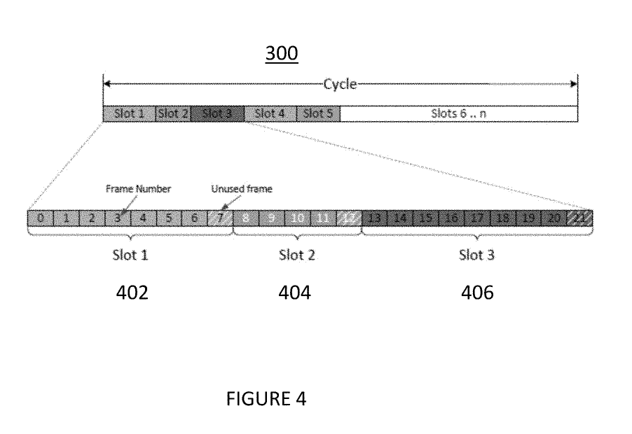

As referenced above, each slot may be of a different size. In some embodiments, the size of a slot may be associated with the number of frames 100 associated with a particular slot. FIG. 4 illustrates an example cycle 300 detailing an example frame assignment, in accordance with certain embodiments of the present disclosure.

In some embodiments, example cycle 300 may include first frame assignment 402, second frame assignment 404, and third frame assignment 406. In some embodiments, each frame assignment is separated by an unused frame. Although, for the purposes of illustration, the unused frame is depicted as occurring at the end of each frame assignment, different configurations would be possible without departing from the scope of the present disclosure.

In some embodiments, first frame assignment 402 may be associated with, for example, a first slot (and accordingly, a first node). In the illustrative example, the first slot includes seven frames, although more, fewer, or different frames may be present without departing from the scope of the present disclosure. Second frame assignment 404 may be associated with, for example, a second slot (and accordingly, a second node). In the illustrative example, the second slot includes five frames, although more, fewer, or different frames may be present without departing from the scope of the present disclosure. Third frame assignment 406 may be associated with, for example, a third slot (and accordingly, a third node). In the illustrative example, the third slot includes nine frames, although more, fewer, or different frames may be present without departing from the scope of the present disclosure.

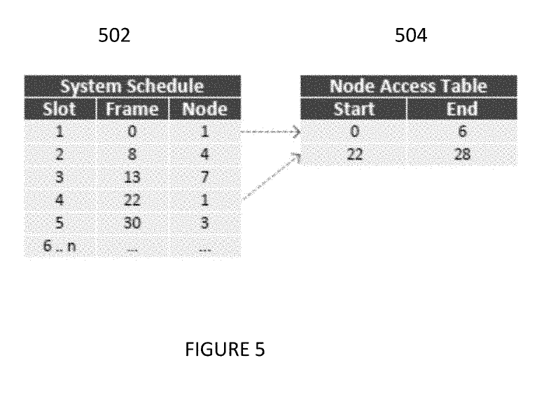

In some embodiments, as described in more detail above with reference to FIG. 2, each frame within a slot may be assigned a number. Further, each frame within a cycle may be assigned a number. With each frame assigned a number and each frame assigned a slot, a master node may establish a synchronous schedule for all slots. FIG. 5 illustrates an example system schedule 500 for scheduling a time-triggered synchronous communication channel, in accordance with certain embodiments of the present disclosure.

In some embodiments, communication on the channel may be done in a repeating cycle where nodes have predetermined slots to transmit in. A slot may be divided over a number of frames. To identify the frame the master node may output either a global frame number or the channel may have the count embedded within the frame bytes. In each cycle the frame count for the channel restarts from 0; if a global count is used it is either masked or nodes keep an internal count based on a common starting frame.

In some embodiments, a system integrator that may be part of a master node (e.g., node 12) may set up the schedule for the whole system and distribute this schedule to participating nodes (e.g., nodes 14, 16). Each node may then set up an access table which determines in what frames that node may transmit. In some embodiments, the master node may distribute the schedule out-of-band (e.g., over the Control Channel on MOST®). The illustrated schedule is static, but one of ordinary skill in the art would recognize that it could be easily switched.

For example, example master schedule 500 may include master schedule 502 and participating node schedule 504. In some embodiments, master schedule 502 may include a plurality of frame, slot, and node assignments. In the illustrative example, slot one, frame zero is assigned to node 1; slot two, frame eight is assigned to node four, slot three, frame thirteen is assigned to node seven; slot four, frame twenty-two is assigned to node one; and slot five, frame thirty is assigned to node three. Thus, the master schedule includes a time-triggered, synchronous communication schedule for each node. The schedule may then be distributed. For example, participating node schedule 504 illustrates an example schedule for participating “node one.” This node (e.g., that referred to as a “first node” in the examples above) has two assigned frames in two different slots: slot one, frame zero; and slot four, frame twenty-two.

A channel for pre-scheduled and time-triggered communication within a synchronous network (MOST®) can be provided which is predictable, highly deterministic and has a low latency. Such a channel in a MOST® system can be used for mission critical communication, like periodic sensor data and control loops.

Thus is disclosed a system and method for a time-triggered communication channel in a synchronous network. The systems and methods provide for the following advantages: It shares physical medium with other MOST® channels: synchronous, isochronous and asynchronous. It reduces cabling. It is flexible and scalable: bandwidth, slot sizes, cycle time and partitioning. It provides for a centrally distributed schedule. The network is synchronized, no need for low-level clock synchronization. The frame number synchronizes the schedule.

What is claimed is:

1. A transmission method in a synchronous network transmitting periodic frames, wherein each frame comprises a plurality of channels, and wherein the network comprises a plurality of nodes, the method comprising the steps of:
communicating in a repeated cycle wherein each of the plurality of nodes has a dedicated slot, wherein a cycle comprises n subsequent slots, and wherein each slot comprises a plurality of frames;
defining a centralized schedule that associates each node to an associated slot comprising a start frame and an end frame; and
transmitting by each node only during the associated slot comprising said start frame.

2. The transmission method according to claim 1, wherein a master node defines the schedule, the master node being one of the plurality of nodes.

3. The transmission method according to claim 1, wherein the schedule is distributed to the plurality of nodes in an out-of-band communication.

4. The transmission method according to claim 1, wherein the schedule is static.

5. The transmission method according to claim 1, wherein the schedule is configurable.

6. The transmission method according to claim 1, wherein each node may be associated with multiple slots within the repeated cycle.

7. The transmission method according to claim 1, wherein one or more of the slots are of different sizes.

8. The transmission method according to claim 1, wherein a cycle length is configurable.

9. The transmission method according to claim 1, wherein a slot comprises at least one unused frame.

10. The transmission method according to claim 9, wherein the unused frame follows after the end frame of a slot.

11. A synchronous network for transmitting periodic frames, wherein each frame comprises a plurality of channels, the synchronous network comprising:
a plurality of nodes communicatively coupled to one another, wherein:
each of the plurality of nodes is operable to communicate in a repeated cycle;
each of the plurality of nodes has a dedicated slot;
a cycle comprises n subsequent slots; and
each slot comprises a plurality of frames;
a master node operable to define a centralized schedule that associates each of the plurality of nodes to an associated slot comprising a start frame and an end frame; and
wherein each of the plurality of nodes is operable to transmit only during the associated slot comprising said start frame.

12. The synchronous network according to claim 11, wherein the master node is further operable to distribute the schedule to the plurality of nodes in an out-of-band communication.

13. The synchronous network according to claim 11, wherein the schedule is static.

14. The synchronous network according to claim 11, wherein the schedule is configurable.

15. The synchronous network according to claim 11, wherein each of the plurality of nodes may be associated with multiple slots within the repeated cycle.

16. The synchronous network according to claim 11, wherein one or more of the slots are of different sizes.

17. The synchronous network according to claim 11, wherein a cycle length is configurable.

18. The synchronous network according to claim 11, wherein a slot comprises at least one unused frame.

19. The synchronous network according to claim 18, wherein the unused frame follows after the end frame of a slot.

20. A synchronous network for transmitting periodic frames, wherein each frame comprises a plurality of channels, the synchronous network comprising:
a plurality of nodes communicatively coupled to one another, wherein:
each of the plurality of nodes is operable to communicate in a repeated cycle;
each of the plurality of nodes has a dedicated slot;
a cycle comprises n subsequent slots; and
each slot comprises a plurality of frames;
a participating node operable to receive a centralized schedule from a master node, wherein the centralized schedule associates each of the plurality of nodes to an associated slot comprising a start frame and an end frame; and
wherein the participating node is operable to transmit only during the associated slot comprising said start frame.
